(19) United States
(12) Patent Application Publication
(10) Pub. No.: US 2017/0195760 A1
(43) Pub. Date: Jul. 6, 2017

(54) Organizer for Personal Listening Devices

(71) Applicant: Larry Tang, East Brunswick, NJ (US)

(72) Inventor: Larry Tang, East Brunswick, NJ (US)

(21) Appl. No.: 15/288,101

(22) Filed: Oct. 7, 2016

Related U.S. Application Data
(60) Provisional application No. 62/245,422, filed on Oct. 23, 2015.

(51) Int. Cl. H04R 1/02; B65D 85/671; A45C 13/10; H04R 1/10; A45C 11/24

(52) U.S. Cl. CPC H04R 1/02; H04R 1/1033; A45C 11/24; A45C 13/10; B65D 85/671

(57) ABSTRACT

An earbuds carrying case hingeably openable and closable in exerting a downward force to hold the earbuds in position and its wound cable connections in place.

### CROSS-REFERENCE TO RELATED APPLICATIONS

A Provisional Patent Application covering the invention described herein was filed on Oct. 23, 2015, and assigned Ser. No. 62/245,422.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

Field of the Invention

This invention relates to organizers for personal listening devices, in general, and to earbuds carrying case configurations which position and hold the earbuds and their cable connections in place, in particular.

Description of the Related Art

As will be appreciated, packaging in which personal listening devices such as earbuds are typically advertised and sold are neither shaped nor designed for their easy carrying about and storing in everyday common usage. More often, whether the packaging be in the shape and size slightly larger than that of a cigarette box, or larger in a contoured plastic box configuration, once the devices are taken out originally, any attempt of replacing them to be stored within the container is difficult to do. And, even thereafter, if successful, even more difficult in trying to carry them about in one's pocket or purse, especially without causing damage to their wire cable interconnections.

Frequently, earbuds are lost—and in the worst case, are broken by someone stepping on them. Even with travel pouches where they can be kept safely, their wire cables often become tangled or knotted when carried about. Leaving the earbuds about adds to the problems of their getting lost, and just pulling them out from one's pants pockets or purse may result in the cable detaching from the housing or from any in-line volume controls that may be present. With the quality and price of expensive earbuds, the need for keeping them safe becomes that much more apparent.

### OBJECTIVES OF THE INVENTION

Appreciating the annoyance of having lost the earbuds, or having them damaged in use, an objective of the present invention is to provide a case for carrying them about. A second objective is having such a case which can be easily and comfortably carried about in one's clothing—or bag or purse for that matter.

### SUMMARY OF THE INVENTION

As will become clear from the following description, the earbuds carrying case organizer of the invention includes an internal frame configuration for the winding about and securement of the cable interconnections within the case, with cut-outs in which the earbud housings are laid. With the case being hingeably openable and closable, a dimensioning and positioning of the internal frame serves to exert a downward force upon the earbuds in holding them in position, as well as holding the wound cable connections in place.

In accordance with the invention, such carrying case organizer can be sized to not only fit comfortably within a pocket or purse, but can be packaged for sale in a common type of hang-tag arrangement from a display hook. A see-through plastic manufacture, where desired, can allow for the visualization through its cover of the earbud components within the case housing, and/or decorated in any alternative fashion. Foam pieces lying on its base can be cut to place and position the components inside, with one or more pillars extending upwards from the base around which the wire cable interconnections can be wound. While sufficient to provide an economical earbuds carrying case organizer,—the case could be enlarged even further to allow additional “ear tips”, or “tools”, or extra component parts added for storage, such as identifying or cosmetic “tags” or “tabs”, as may be desired.

### BRIEF DESCRIPTION OF THE DRAWINGS

These and other features of the present invention will be more clearly understood from a consideration of the following description, taken in connection with the accompanying Drawings in which:

FIGS. 1A-1D are 4 views of an earbuds carrying case organizer in accordance with a first embodiment of the invention;

FIGS. 2A-2F are 6 views of an earbuds carrying case organizer according to a second embodiment of the invention;

FIGS. 3A-3B are 2 views helpful in an understanding of the invention illustrating a manner of storing a pair of earbuds in the carrying case organizer of FIGS. 2A-2F; and

FIGS. 4A-4F are 6 views of a third earbuds carrying case organizer embodiment according to the invention.

### DETAILED DESCRIPTION OF THE INVENTION

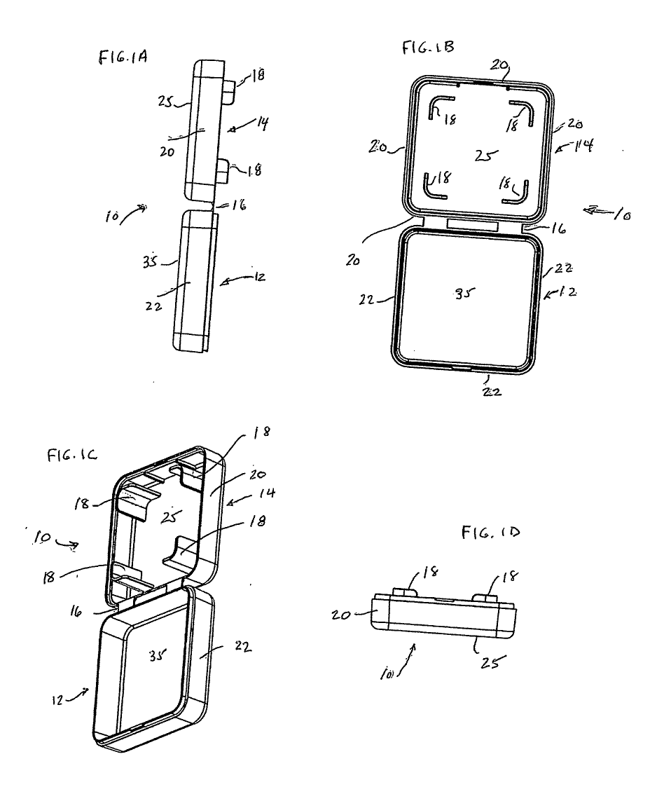

In the views of FIGS. 1A-1D, the earbuds carrying case organizer 10 (hereinafter simply referred to as a “case” or “carrying case”) includes a top or cover portion 12 and a bottom or base portion 14. A living hinge 16 joins the portions 12 and 14 so that the cover portion 12 can snugly fit over the base portion 14 in opening and closing the case 10. Four pillars 18 adjacent opposing corners of the base portion 14 extend upwardly beyond the height of the base portion 14 in extending towards the cover portion 12—as depicted in FIG. 1A with the cover portion 12 open, and in FIG. 1D within the cover portion 12 removed. Each of the pillars 18 is set inwardly between the side walls 20 of the base portion 14, and inwardly between the side walls 22 of the cover portion 12 when lowered closed in allowing the wire cable interconnections of the earbuds to be wound around the pillars 18, in being held in place within the earbuds carrying case when the cover portion 12 is closed. In these respects, FIG. 1A is a side view of the case when opened, FIG. 1B is a top view of the opened case, FIG. 1C is a side perspective view of the opened case and FIG. 1D is a front view of the bottom portion 14 of the case 10. As will be seen, the pillars 18 extend upwardly from a bottom 25 of the bottom portion 14 into the top portion 12 towards its top 35.

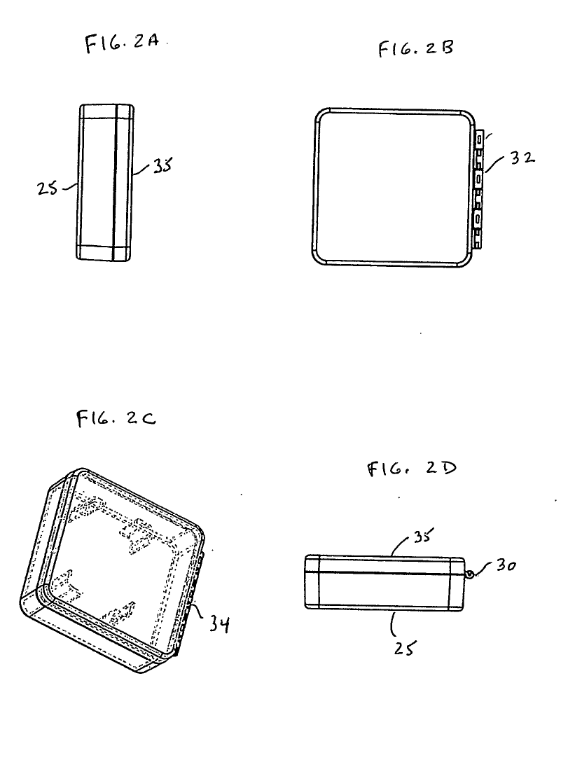

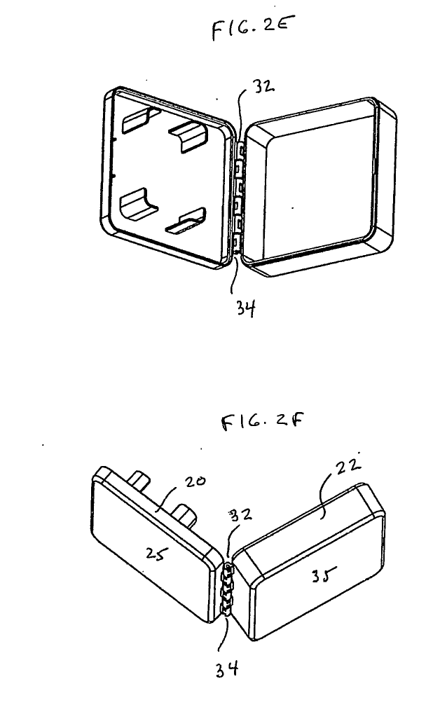

The second embodiment of the invention shown in FIGS. 2A-2F replaces the living hinge 16 of FIGS. 1A-1D to simplify a tooling manufacture. In the embodiment of FIGS. 2A-2F, mating hinge components on the cover portion 12 and on the base portion 14 are joined together by a stud 30 illustrated in FIG. 2D. With the hinge components shown as 32, 34 in FIGS. 2E and 2F, the views of these figures respectively are: a side view of the carrying case closed (FIG. 2A, a top view of the closed carrying case (FIG. 2B), a top perspective view of the closed case 10 with the pillars 18 shown in “phantom” (FIG. 2C), a front view of the closed case (FIG. 2D), a front perspective view of the carrying case with the cover portion 12 open (FIG. 2E), and a rear perspective view of the carrying case when opened (FIG. 2F). As will be appreciated by those skilled in the art, the pillars 18, to prevent unraveling of the wire cable interconnections once wound, extend upwardly from the bottom 25 of the base portion 14 towards the underside of the top 35 of the cover portion 12—either reaching it or falling just short of it, in allowing the cover portion 12 to press downwardly upon any wire cable windings that may seek to overlap above the pillars 18. This would be the situation where the side walls 20 which define the configuration of the base meet the side walls 22 which define the configuration of the cover (as in FIGS. 1A-1D, 2A-2F and 3A-3B), or in an alternative embodiment where the side walls 22 overlap the side walls 20 in a closing of the case.

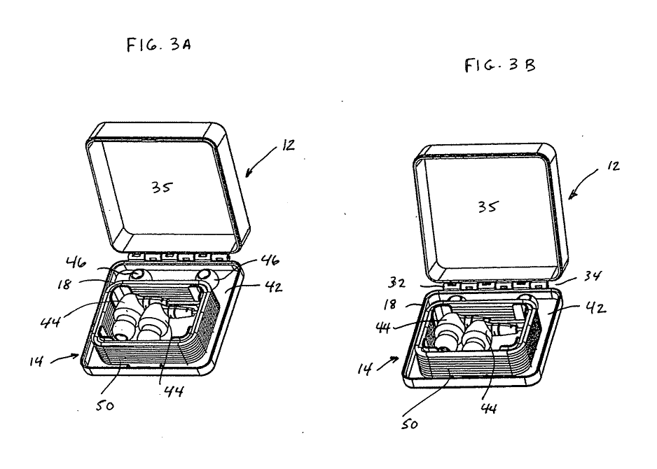

FIGS. 3A and 3B illustrate the hand windings of the wire cable interconnections 50 about the pillars 18 on a foam or like layer 42. The earbuds are shown at 44, and additional “ear tips” 46 are included in the carry case 10 within cut-outs in the foam layer. With FIG. 3A showing more of a top view of the base portion 14 with the wire cables in place than in the view of FIG. 3B, a rotational lowering of the cover portion 12 to close the case for each of the FIGS. 3A and 3B configurations then results in the closed case depiction of FIG. 2D. As will be understood, the resulting case can be made just slightly larger than the length of the earbuds themselves—especially if the case were manufactured without the cut-outs for additional “ear tips” as in FIGS. 3A and 3B. The carrying case once closed would then be of a small enough size to easily fit within a pocket, bag or purse, and be easily removable therefrom, while at the same time protecting any damage to the wire cable or the interconnections with the earbuds themselves. The top 35 of the cover portion 12 could be of a plastic or see-through plastic composition in such an arrangement, or decorated in any manner that might be desired. At the same time, being of such a diminished size, the earbuds carrying case of the drawings can easily be fitted within almost any packaging selected, for easy hang-tag presentation in a store or counter location—as for ease of storage or display. And, once the earbuds are removed from the case, it becomes but a simple matter to rewind the wire cabling 50 around the pillars 18 in securing the earbuds in the protective case enclosure when the cover 12 is lowered.

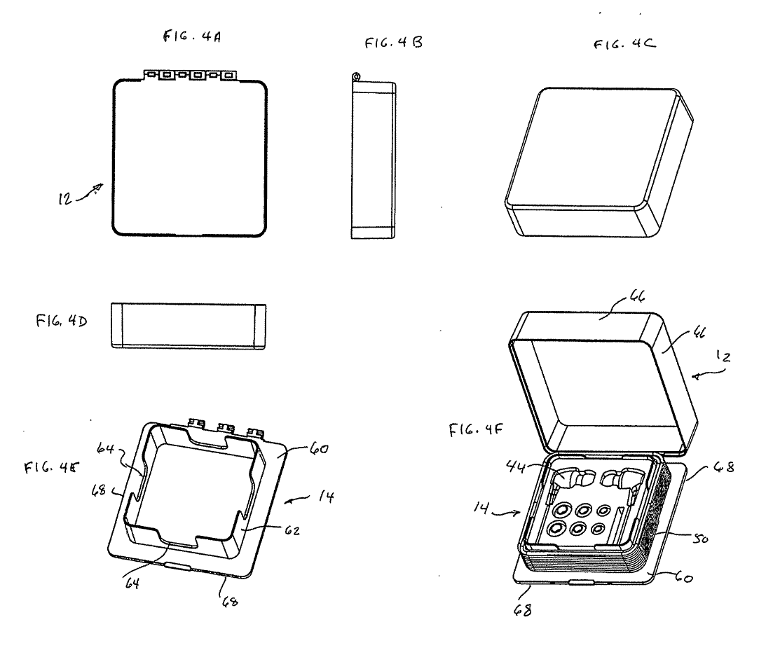

The third embodiment of the invention shown in FIGS. 4A-4F replaces the upwardly extending side walls 20 from the bottom portion 14 of the first two embodiments, essentially leaving the base flat, as at 60. Additionally, the 4 separate pillars 18 employed in those embodiments are joined as corners in a connecting, upwardly extending 4 sided wall 62, around which the wire cabling 50 of the earbuds is to be wound. Such wall 62 may further be notched at each side (as at 64) to facilitate the later placement of the earbuds 44 and the “eartips” 46. The height of this 4-sided wall 62 is such as to reach to, or fall slightly less in reaching, the top of the cover portion 12 once the case is closed.

The views of FIG. 4A-4F respectively are: a top view of the cover portion 12 (FIG. 4A), a bottom view being a mirror image; a left side view of the cover portion (FIG. 4B), a right side view also being a mirror image; a top perspective view of the closed case (FIG. 4C); a front view of the closed case (FIG. 4D); a top perspective view of the bottom portion (FIG. 4E); and a top perspective view of the opened case with the earbuds 44 and wire cabling 50 in position (FIG. 4F). As will be appreciated, whereas the downwardly extending side walls 22 of the top or cover portion 12 meet with the upwardly extending side walls 20 of the bottom or base portion 14 in the embodiments of FIGS. 1A-1D, 2A-2F and 3A-3B, the downwardly extending side walls 66 of the top or cover portion 12 of FIG. 4F overlap the pillar corners of the connecting wall 62 in this embodiment to extend to a top surface of the flat base 60, or even to envelop around the side edges of the base 60, shown at 68.

As will be understood, the embodiment of FIG. 4A-4F illustrates a further advantage of the invention beyond that offered by the first two embodiments. In particular, the embodiments of FIGS. 1A-1D, 2A-2F and 3A-3B illustrate not only a designed organization of the earbud type carrying case, but the ease in which the earbuds can be taken out of the case without tangling of the wire cabling 50. That is, users of earbud type personal listening devices recognize that it is relatively easy to just coil the wires for storage, and then to straighten them out for use with typical design construction, even though it may be a hassle to do so when the wires are all tangled, needing time to uncoil them. With the invention as shown in FIGS. 1A-1D, 2A-2F and 3A-3B, the wires stored in the carrying case organizer of the invention are very easily released from about the pillars 18 in facilitating the straightening, and in less time. With the embodiment of FIG. 4A-4F, the ease of removal and arrangement for subsequent use follows through the notching at 64 to allow the grasping of the wire cabling 50 for release that much more fundamental.

While there have been described what are considered to be preferred embodiments of the present invention, it will be readily apparent to those skilled in the art that modifications can be made without departing from the scope of the teachings herein. Thus, for example, while the preferred embodiments include 4 individually corner positioned pillars around which the wire cable interconnections are wound, other positionings may be employed instead, as with only 2 or 3 pillars, or even just 1 pillar utilized (as long as the pillar(s) extends from the bottom 25 of the base portion 14 to reach to or just fall short of the top 35 of the cover portion 12 in securing the interconnections in place, against unraveling). Similarly, while the side walls in the drawings define orthogonal configurations illustrative of a carrying case organizer that is “square” when closed, they likewise could be configured to form a rectangular, triangular, circular or other look for a case organizer in accordance with the invention. For at least such reasons, therefore,—and for the reason that the carrying case features of the invention are also applicable to the storage and transportation of personal listening devices other than earbuds—resort should be had to the appended claims for a true understanding of the teachings hereof.

I claim:

1. An organizer for a personal listening device comprising:
a carrying case, said case having:
a bottom portion defining a configuration of a base for said case;
a top portion having downwardly extending side walls defining a configuration of a cover for said case;
and at least one pillar extending upwardly from said bottom portion into said top portion upon closure of said case a distance equal to reach, or fall only slightly less in reaching, a top of said top portion of said case.

2. The organizer of claim 1 wherein said case includes a hinge between said bottom portion of said case and said top portion of said case.

3. The organizer of claim 1 wherein said case includes a living hinge between said bottom portion of said case and said top portion of said case.

4. The organizer of claim 2 wherein said bottom portion of said case and said top portion of said case are each of a plastic composition.

5. The organizer of claim 4 wherein said top portion of said case is of a see-through plastic composition.

6. The organizer of claim 2 wherein said bottom portion of said case defines an orthogonal configuration of a base for said bottom portion, and wherein said side walls of said top portion of said case define an orthogonal configuration of a cover for said top portion.

7. The organizer of claim 6 wherein said case includes 4 pillars, each extending upwardly from said bottom portion of said case into said top portion of said case upon closure of said case a distance equal to or only slightly less than a height of said side walls of said top portion of said case.

8. The organizer of claim 2 wherein said case includes a pair of earbuds upon said bottom portion of said case, with wire cable interconnections wound around at least said one pillar extending upwardly from said bottom portion of said case.

9. The organizer of claim 7 wherein said case includes a pair of earbuds upon said bottom portion of said case, with wire cable interconnections wound around each of said 4 pillars extending upwardly from said bottom portion of said case.

10. The organizer of claim 9 wherein said bottom portion of said case and said top portion of said case are each of a plastic composition.

11. The organizer of claim 10 wherein said top portion of case is of a see-through plastic composition.

12. The organizer of claim 1 wherein said bottom portion of said case includes upwardly extending side walls, with the side walls of each of said bottom portion of said case and said top portion of said case overlapping or joining in forming a closure of said case, and wherein at least one pillar extends upwardly from a bottom of said bottom portion a distance greater than a height of said side walls of said bottom portion of said case.

13. The organizer of claim 12 wherein said case includes a hinge between a side wall of said bottom portion of said case and an adjacent side wall of said top portion of said case.

14. The organizer of claim 13 wherein said case includes a living hinge between a side wall of said bottom portion of said case and an adjacent side wall of said top portion of said case.

15. The organizer of claim 13 wherein said side walls of said bottom portion of said case define an orthogonal configuration of a base for said bottom portion, and wherein said side walls of said top portion of said case define an orthogonal configuration of a cover for said top portion.

16. The organizer of claim 15 wherein said case includes 4 pillars, each extending upwardly from said bottom portion of said case at adjacent side walls of said case and into said top portion of said case upon closure of said case a distance equal to or only slightly less than a height of said side walls of said top portion of said case.

17. The organizer of claim 6 wherein said case includes 4 pillars configured as corners in a connecting wall extending upwardly from said bottom portion of said case into said top portion of said case upon closure of said case a distance equal to or only slightly less than a height of said top walls of said top portion of said case.

18. The organizer of claim 17 wherein said case includes a pair of earbuds upon said bottom portion of said case within an enclosure defined by said connecting wall, with wire cable interconnections wound around said connecting wall extending upwardly from said bottom portion of said case.

19. The organizer of claim 18 wherein said connecting wall is notched between adjacent pairs of said 4 pillars.

20. An organizer for a personal listening device comprising:
a carrying case, said case having:
a bottom portion defining a configuration of a base for said case;
a top portion having downwardly extending side walls defining a configuration of a cover for said case;
4 pillars, each extending upwardly from said bottom portion of said case into said top portion of said case upon closure of said case a distance equal to or only slightly less than a height of said side walls of said top portion of said case;
wherein said case includes a pair of earbuds upon said bottom portion of said case, with wire cable interconnections wound around each of said 4 pillars extending upwardly from said bottom portion of said case;
and wherein said case includes a hinge between a side wall of said bottom portion of said case and an adjacent side wall of said top portion of said case.
